(19) United States
(12) Patent Application Publication
(10) Pub. No.: US 2019/0008311 A1
(43) Pub. Date: Jan. 10, 2019

(54) IMITATION POUR-OVER COFFEE MACHINE DEVICE HAVING 3-AXIS DUAL-PLANE INTERACTING ACTUATOR

(71) Applicants: Hsien-Jen LIN, Taipei (TW); Tzu-Chi LIN, Taipei (TW)

(72) Inventors: Hsien-Jen LIN, Taipei (TW); Tzu-Chi LIN, Taipei (TW)

(21) Appl. No.: 16/030,290

(22) Filed: Jul. 9, 2018

Related U.S. Application Data
(60) Provisional application No. 62/530,405, filed on Jul. 10, 2017.

(51) Int. Cl. A47J 31/06; A47J 31/52; A47J 31/46; A47J 31/44

(52) U.S. Cl. CPC A47J 31/0631; A47J 31/4482; A47J 31/46; A47J 31/52

(57) ABSTRACT

The present invention provides an imitation pour-over coffee machine device having 3-axis dual-plane interacting actuator, comprising: a body comprising a base having a water tank, a pump and a heating unit; an UI module; a brewing module comprising: a first driving module and a second driving module driving a dispensing head to move up, down, front and back; a co-brewing module controlling the cup carrier to rotate by a third driving module; a controlling module reading a signal of the UI module and then controls the actuation of the pump, the heating unit, the brewing module, and the co-brewing module. Through the implementation of the present invention, an effect of imitation pour-over coffee can be achieved.

### BACKGROUND OF THE INVENTION

### 1. Technical Field

The present disclosure relates to imitation pour-over coffee machine devices having 3-axis dual-plane interacting actuator and, more particularly, to an imitation pour-over coffee machine device having 3-axis dual-plane interacting actuator that achieves imitated pour-over coffee brewing automatically by an imitated pour-over coffee brewing process.

### 2. Description of Related Art

The global consumption market for people's livelihood is thriving, and the performance of the beverage market therein makes a great contribution. With the development of the beverage market so far, there are too many varieties to see. Global consumers do not stick to traditional preferences any more, and start to try different beverage varieties. One of examples is the flourish of the global market of coffee, tea, scented tea, fruit tea, traditional Chinese medicine health-care tea, etc.

In terms of coffee, as caffeine can stimulate the central nervous system, the brain is clear in a short time, working efficiency can be increased, and both attention and reaction become fast. Caffeine can also help to decrease the difficulty of exercise and increase the performance of exercise. Caffeine also has the effect of constricting the blood vessel, and thereby can treat the headache symptom caused by blood vessel expansion. Therefore, coffee has gradually become an indispensable part of people's lives, even a part of life style.

Pour-over coffee is always popular with coffee drinkers, because its mouthfeel and flavor not only differs from person to person but is also distinguished. However, not only is pour-over coffee offered at high prices, but brewing delicious pour-over coffee also require considerable training and expertise. Therefore, brewing imitated pour-over coffee smartly with automated equipment would work to coffee businesses' and consumers' benefit.

### SUMMARY OF THE INVENTION

The present disclosure relates to an imitation pour-over coffee machine device having 3-axis dual-plane interacting actuator which provides consistent mouthfeel by brewing imitated pour-over coffee with automated equipment.

The present invention provides an imitation pour-over coffee machine device having 3-axis dual-plane interacting actuator, comprising: a body comprising a main casing and a base, the base having therein a water tank, a pump and a heating unit, the heating unit having a water inlet in communication with the water tank through the pump; a human-machine interface module coupled to the main casing from above; a brewing module comprising: a first driving module having a first moving unit for performing a X-axis motion operation; a second driving module fixedly disposed on the first moving unit and having a second moving unit for performing a Y-axis motion operation; and a dispensing head fixedly disposed on the second moving unit and having a water inlet in communication with a water outlet of the heating unit; a co-brewing module comprising: a cup carrier disposed at the base; and a third driving module for controlling the cup carrier to perform a Z-axis rotation operation; and a controlling module for reading a signal of the human-machine interface module and then controlling operation of the pump, the heating unit, the brewing module, and the co-brewing module. The first driving module, the second driving module, and the third driving module are configured to form the imitation pour-over coffee machine devices having 3-axis dual-plane interacting actuator in the manner of the X-axis, the Y-axis, and the Z-axis interacting.

The present disclosure can be implemented to achieve at least the inventive advantages as follows:

1. perform imitated pour-over coffee brewing with automated equipment;

2. enable users to brew delicious pour-over coffee conveniently without training; and

3. brew imitated pour-over coffee massively and efficiently with automated equipment and create novel commercial models.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE DRAWINGS

FIG. 1 is a perspective schematic view of an imitation pour-over coffee machine device having 3-axis dual-plane interacting actuator according to an embodiment of the present disclose;

FIG. 2A is a partial perspective schematic view of an embodiment of the present disclose;

FIG. 2B is an exploded view of a brewing module according to an embodiment of the present disclose;

FIG. 3 is a partial cross-sectional view of an embodiment of the present disclose;

FIG. 4 is a block diagram of an embodiment of the present disclose;

FIG. 5A is a perspective schematic view of how to perform an imitated pouring over process according to an embodiment of present disclosure; and

FIG. 5B is a schematic diagram of 3-axis and dual-plane formed by the brewing module and the brewing module of the present invention.

### DETAILED DESCRIPTION OF THE INVENTION

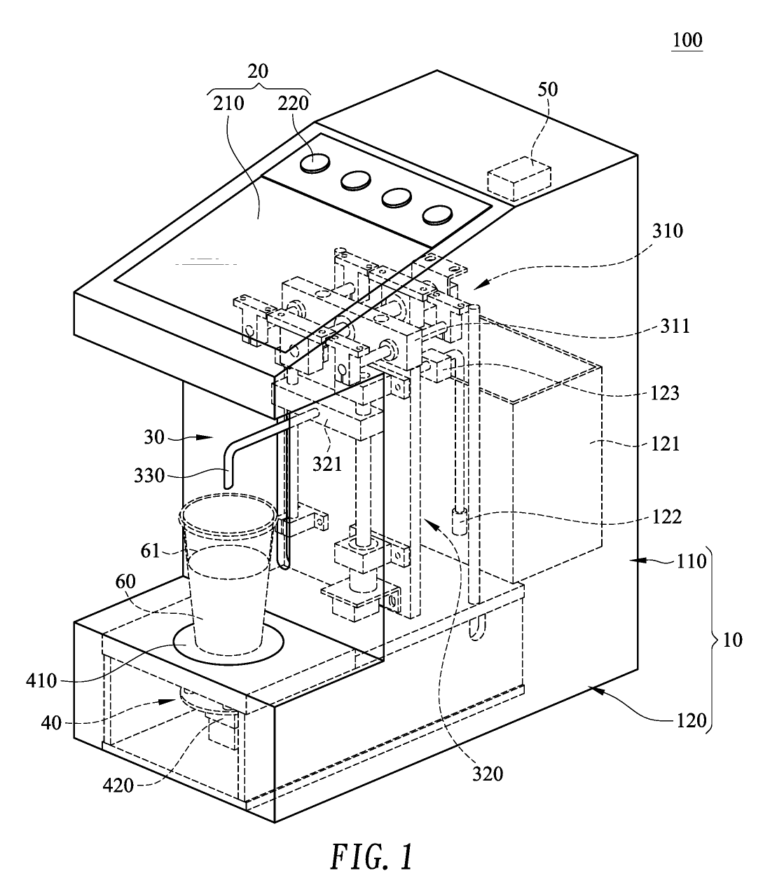

As shown in FIG. 1, this embodiment relates to an imitation pour-over coffee machine device having 3-axis dual-plane interacting actuator 100 comprising a body 10, a human-machine interface module 20, a brewing module 30, a co-brewing module 40, and a controlling module 50.

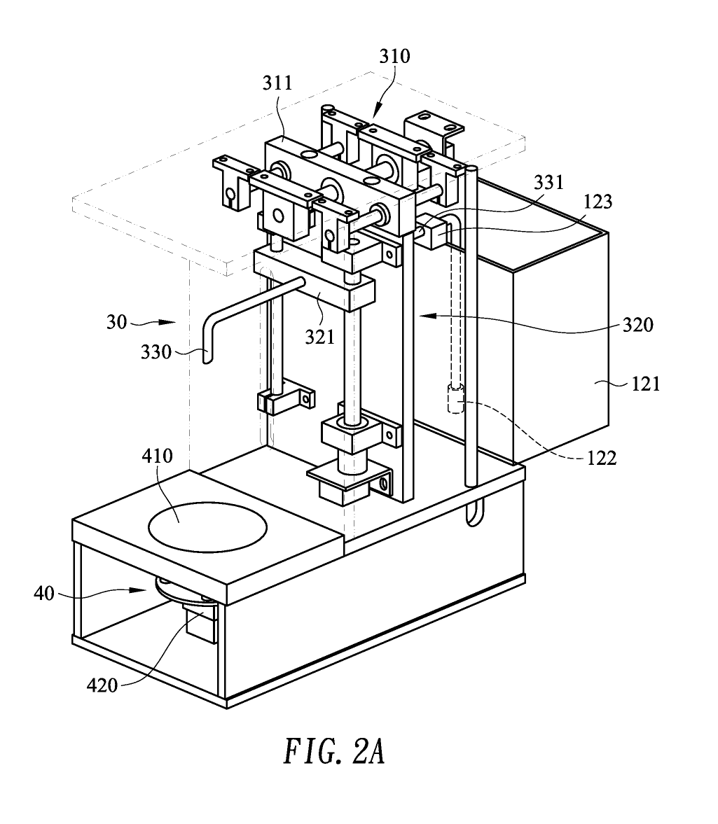

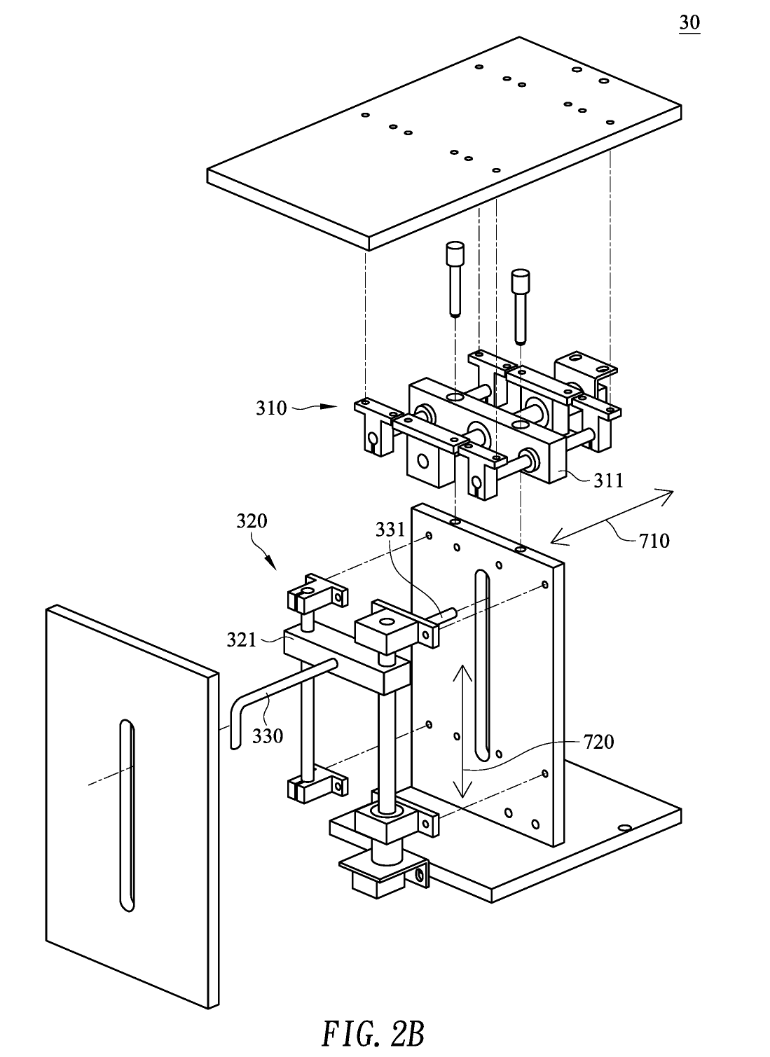

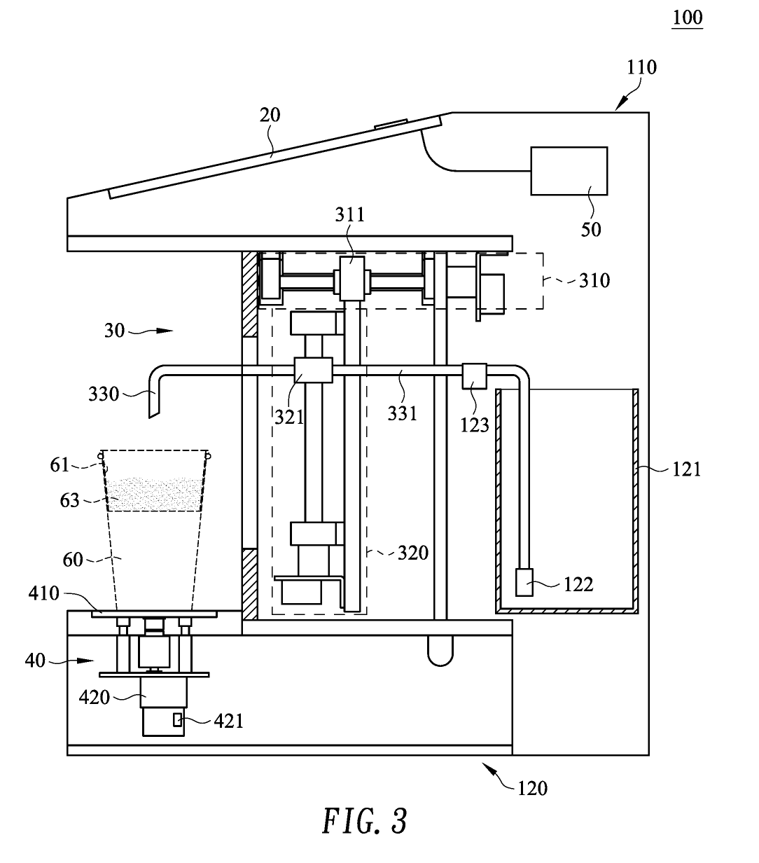

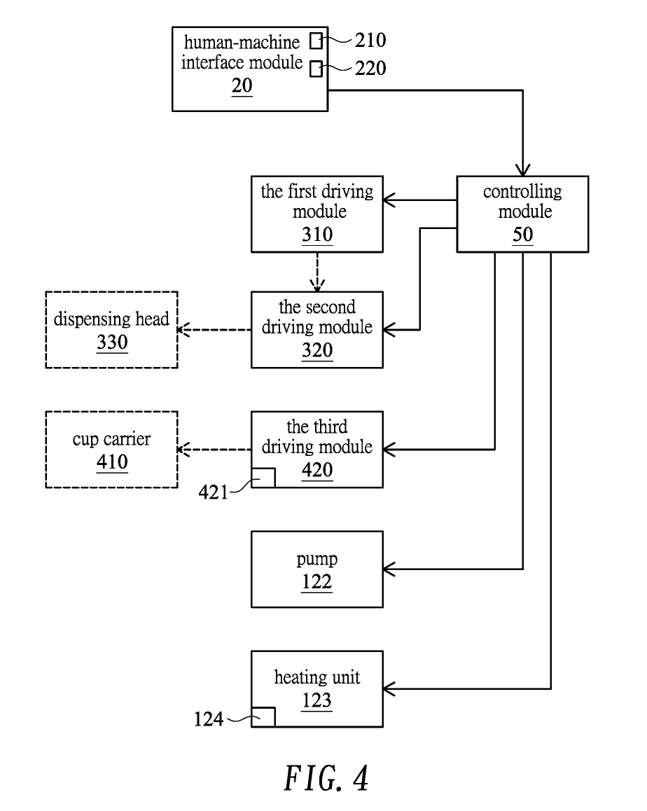

As shown in FIG. 2A through FIG. 4, the body 10 is essentially a housing and comprises a main casing 110 and a base 120. The main casing 110 receives a human-machine interface module 20, a brewing module 30, a controlling module 50, a water tank 121, a pump 122 and a heating unit 123. The base 120 has therein a co-brewing module 40.

A water inlet of the heating unit 123 is in communication with the water tank 121 through the pump 122; hence, water in the water tank 121 is delivered with the pump 122 to the heating unit 123 to instantly supply hot water required for brewing coffee. To exercise precise control over the hot water thus supplied, the heating unit 123 has a temperature controller 124 for adjusting and controlling temperature by, for example, pulse width modulation (PWM), such that the heating unit 123 is temperature-controllable.

The human-machine interface module 20 enables users to select options of brewing coffee. The human-machine interface module 20 is coupled to the main casing 110 from above, and thus the users can operate the imitation pour-over coffee machine device having 3-axis dual-plane interacting actuator 100 conveniently. The human-machine interface module 20 is a touchscreen 210 or a button assembly 220.

The brewing module 30 comprises a first driving module 310, a second driving module 320, and a dispensing head 330.

The first driving module 310 has a first moving unit 311 for performing a X-axis motion operation. The X-axis motion operation is a horizontal/X-axis motion operation 710. To control the distance of motion precisely, the first driving module 310 is a linear rail or a ball-crew positioning actuator.

The second driving module 320 is fixedly disposed on the first moving unit 311. Therefore, the second driving module 320 moves synchronously with the first moving unit 311.

The second driving module 320 has a second moving unit 321 for performing a Y-axis motion operation. The Y-axis motion operation is a vertical/Y-axis motion operation 720. Similarly, to control the distance of motion precisely, the second driving module 320 is a linear rail or a ball-crew positioning actuator.

The dispensing head 330 supplies hot water required for brewing coffee. The dispensing head 330 is provided in the form of a pipe. The dispensing head 330 is fixedly disposed on the second moving unit 321. Therefore, the dispensing head 330 moves synchronously with the second moving unit 321. The dispensing head 330 has a water inlet in communication with a water outlet of the heating unit 123 through a water pipe 331; hence, the dispensing head 330 can supply hot water for use in brewing coffee.

The co-brewing module 40 comprises a cup carrier 410 and a third driving module 420.

The cup carrier 410 is a rotatable disk holding a coffee cup 60 containing coffee to be brewed. The cup carrier 410 is disposed at the base 120 and below the dispensing head 330 to facilitate coffee brewing.

The third driving module 420 is a motor. The third driving module 420 controls the cup carrier 410 to perform a Z-axis rotation operation 730. To control the rotation speed of the motor efficiently, the third driving module 420 has a rotation speed controller 421 for controlling the rotation speed of the motor efficiently by, for example, pulse width modulation (PWM).

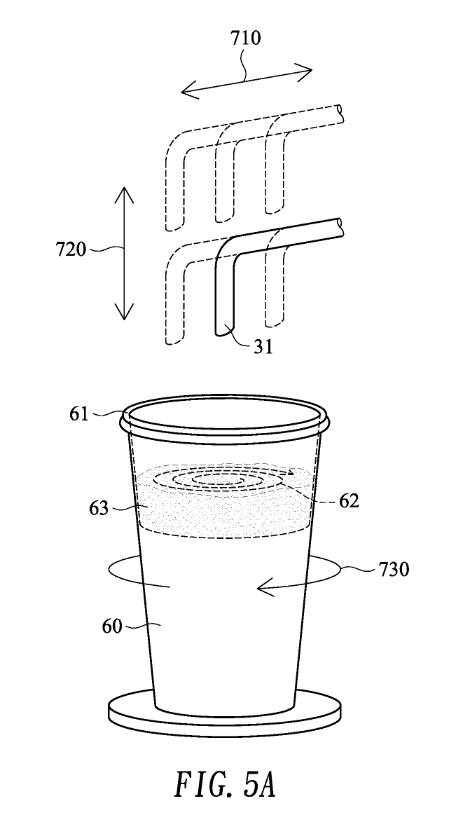

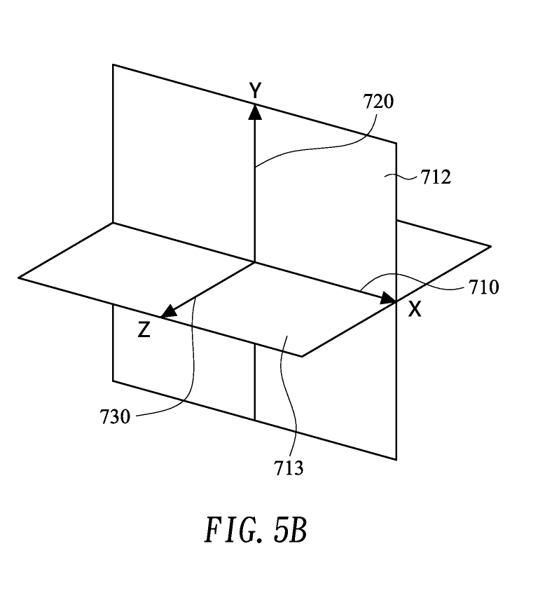

As shown in FIG. 5A and FIG. 5B, the first driving module 310 and second driving module 320 may constitute an operation of the first/X-Y plane 712, which enable the dispensing head 330 to perform upward, downward, forward and backward brewing operations. These, together with the third driving module 420, cause the coffee cup 60 to be brewed to perform the second/X-Z plane 713 rotation operation, so as to achieve a pour-over operation 62 in the manner of the X-axis, the Y-axis, and the Z-axis interaction for imitated pour-over coffee machine device having 3-axis dual-plane interacting actuator.

In addition to the aforesaid pour-over operation pertaining to the imitated pour-over coffee, optimization of the imitated pour-over coffee requires a combination of a coffee flavor anticipated by the users, various brewing process flows and different brewing parameters, which are described later.

The controlling module 50 controls the imitation pour-over coffee machine device having 3-axis dual-plane interacting actuator 100 with a designed, planned built-in program. The controlling module 50 is a programmable controller, such as a microcontroller unit (MCU). The controlling module 50 is electrically signal-connected to the pump 122, the heating unit 123, the human-machine interface module 20, the brewing module 30, and the co-brewing module 40.

To operate the human-machine interface module 20, the users enter a brewing command into the human-machine interface module 20 to enable the human-machine interface module 20 to generate and send a control signal to the controlling module 50. Then, the controlling module 50 controls the modules or components of the imitation pour-over coffee machine device having 3-axis dual-plane interacting actuator 100 in accordance with the predefined, built-in program code, so as to accomplish the coffee brewing anticipated by the users.

To describe the operation mode of the human-machine interface module 20 and explain how to brew the imitated pour-over coffee, the design of the human-machine interface module (UI module) 20 and the controlling module 50 is illustrated with the table below for exemplary purposes.

| | controlling | | | | | | |
|---|---|---|---|---|---|---|---|
| | module | | | | | | |
| | | bean | | | first | second | third |
| UI | | soaking | | | instance | instance | instance |
| module | cup | and | water | water | of | of | of |
| (flavor) | warming | preheating | temperature | quantity | brewing | brewing | brewing |
| Americano | V (done) | V (done) | 93° C. | 150 cm³ | 50 cm³ | 50 cm³ | 50 cm³ |
| Caffè Latte | V (done) | V (done) | 94° C. | 130 cm³ | 60 cm³ | 70 cm³ | X (not |
| | | | | | | | done) |
| Espresso | V (done) | V (done) | 95° C. | 80 cm³ | 20 cm³ | 30 cm³ | 30 cm³ |

First, the human-machine interface module 20 is pre-configured with flavor options anticipated by the users, such as Americano, Caffè Latte, and Espresso. Afterward, the built-in program imitates conventional process flows of brewing pour-over coffee, such as cup warming, bean soaking and preheating, first instance of brewing, second instance of brewing, third instance of brewing, and so on. These, together with parameters, such as timing and water temperature, allow imitated pour-over coffee brewing to be carried out.

Cup warming involves warming a piece of coffee filter paper (which has not yet been loaded with coffee granules) with hot water and washing out the smell of the filter paper. At this point in time, the controlling module 50 controls how much and for how long hot water is to dispense, whereas the first driving module 310, second driving module 320 or third driving module 420 controls the area which the hot water is to fall on.

Bean soaking and preheating involves loading the coffee filter paper with coffee granules 63 and then soaking the coffee granules 63 in the hot water such that the coffee granules 63 each absorb water and are pre-heated. At this point in time, the controlling module 50 also controls how much and for how long hot water is to dispense, whereas the first driving module 310, second driving module 320 or third driving module 420 allows all the coffee granules 63 to be brewed with the hot water, without allowing the hot water to drip.

The water temperature, water quantity, first instance of brewing, second instance of brewing, and third instance of brewing are set beforehand with the program according to the attributes of each coffee flavor. Afterward, the controlling module 50 controls imitated pour-over coffee brewing in conjunction with the heating unit 123, pump 122, first driving module 310, second driving module 320, and third driving module 420.

The description of the aforesaid parameters merely serves exemplary purposes. Priority of each of the parameters can be planned by the users' operating the human-machine interface module 20. In this embodiment, the dispensing head 330 and the coffee cup 60 rotate and interact with each other under the control of a coffee filter paper container 61, the first driving module 310, the second driving module 320 or the third driving module 420 to enable the imitation pour-over coffee machine device having 3-axis dual-plane interacting actuator 100 to brew imitated pour-over coffee with the same effect or flavor as manually brewed coffee.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. An imitation pour-over coffee machine device having 3-axis dual-plane interacting actuator, comprising:
a body comprising a main casing and a base, the base having therein a water tank, a pump and a heating unit, the heating unit having a water inlet in communication with the water tank through the pump;
a human-machine interface module coupled to the main casing from above;
a brewing module comprising:
a first driving module having a first moving unit for performing a X-axis motion operation;
a second driving module fixedly disposed on the first moving unit and having a second moving unit for performing a Y-axis motion operation; and
a dispensing head fixedly disposed on the second moving unit and having a water inlet in communication with a water outlet of the heating unit;
a co-brewing module comprising:
a cup carrier disposed at the base; and
a third driving module for controlling the cup carrier to perform a Z-axis rotation operation; and
a controlling module for reading a signal of the human-machine interface module and then controlling operation of the pump, the heating unit, the brewing module, and the co-brewing module;
wherein the first driving module, the second driving module, and the third driving module are configured to form the imitation pour-over coffee machine devices having 3-axis dual-plane interacting actuator in the manner of the X-axis, the Y-axis, and the Z-axis interacting.

2. The imitation pour-over coffee machine device having 3-axis dual-plane interacting actuator of claim 1, wherein the human-machine interface module is a touchscreen or a button assembly.

3. The imitation pour-over coffee machine device having 3-axis dual-plane interacting actuator of claim 1, wherein the heating unit is a temperature-controllable heating unit.

4. The imitation pour-over coffee machine device having 3-axis dual-plane interacting actuator of claim 1, wherein the x-axis motion operation is a horizontal motion operation.

5. The imitation pour-over coffee machine device having 3-axis dual-plane interacting actuator of claim 1, wherein the Y-axis motion operation is a vertical motion operation.

6. The imitation pour-over coffee machine device having 3-axis dual-plane interacting actuator of claim 1, wherein the first driving module is a linear rail or a ball-crew positioning actuator.

7. The imitation pour-over coffee machine device having 3-axis dual-plane interacting actuator of claim 1, wherein the second driving module is a linear rail or a ball-crew positioning actuator.

8. The imitation pour-over coffee machine device having 3-axis dual-plane interacting actuator of claim 1, wherein the third driving module is a motor.

9. The imitation pour-over coffee machine device having 3-axis dual-plane interacting actuator of claim 1, wherein the controlling module is a programmable controller.

10. The imitation pour-over coffee machine device having 3-axis dual-plane interacting actuator of claim 9, wherein the programmable controller is a microcontroller unit.
